(19) United States
(12) Patent Application Publication
(10) Pub. No.: US 2026/0133725 A1
(43) Pub. Date: May 14, 2026

(54) PROVIDING FEEDBACK TO A USER OF A HAND-HELD INKJET PRINTER

(71) Applicant: Hewlett-Packard Development Company, L.P., Spring, TX (US)

(72) Inventors: Oriol SOLA TAPIAS, Sant Cugat del Valles (ES); Ricard SILVESTRE RIVERO, Sant Cugat del Valles (ES); Xavier OLIVA VENTAYOL, Sant Cugat del Valles (ES)

(73) Assignee: Hewlett-Packard Development Company, L.P., Spring, TX (US)

(21) Appl. No.: 18/695,668

(22) PCT Filed: Sep. 27, 2021
(86) PCT No.: PCT/US2021/052200

§ 371 Date: Mar. 26, 2024

(51) Int. Cl. G06F 3/12; B41J 3/36

(52) U.S. Cl. CPC G06F 3/1208; B41J 3/36; G06F 3/1259

(57) ABSTRACT

There is provided a system for providing feedback to a user of a hand-held inkjet printer, the system comprising a controller configured to determine an acceptable range of speed of the hand-held printer during printing as a function of a print job and a feedback device to provide feedback depending on the acceptable range of speed and a current speed of the hand-held printer during printing. There are also provided a hand-held inkjet printer, a non-transitory machine-readable storage medium and a method for reacting to a usage of a hand-held inkjet printer.

### BACKGROUND

Some example printing devices are to be held in the hand of a user and operated by the user while the user is holding the printing device, i.e., being a user-propelled inkjet printer.

### BRIEF DESCRIPTION OF THE DRAWINGS

Examples will now be described, by way of non-limiting examples, with reference to the accompanying drawings, in which:

FIG. 1 shows a schematic view of an example system for providing feedback.

FIG. 2 shows a schematic view of an example system for providing feedback.

FIG. 3A shows a schematic view of an example system for providing feedback.

FIG. 3B shows a schematic view of an example system for providing feedback.

FIG. 3C shows a schematic view of an example system for providing feedback.

FIG. 4A shows a schematic view of an example system for providing feedback.

FIG. 4B shows a schematic view of an example system for providing feedback.

FIG. 5 shows a schematic view of an example system for providing feedback.

FIG. 6 shows an example system comprising a kiosk and a base station comprising a system for providing feedback.

FIG. 7 shows a representation of a hand-held inkjet printer.

FIG. 8 shows a representation of a hand-held inkjet printer.

FIG. 9 is a schematic view of an example non-transitory machine-readable storage medium.

FIG. 10 is a schematic representation of a method for providing feedback to a user of a hand-held inkjet printer.

### DETAILED DESCRIPTION

Some devices are able to print images, for example customized images, onto substrates. Some example substrates include wearable garments (for example, t-shirts, etc.). The devices enable a user to print customized content on items that they may be intending to wear. Some devices achieve a personalized printing of an image to a substrate by heat-pressing a pre-cut substrate having the image printed thereon to a final substrate, or by printing to the substrate and post-processing the substrate. This may, in some examples, also be done manually (e.g., using ink and an applicator), e.g., by a user.

Some inkjet printers comprise a printhead or printheads mounted on a printhead carriage. A printhead is a device containing and spitting ink. The printhead carriage moves across a print zone with a controlled speed, and a printing media advances in a controlled way for an optimal print quality. Such control is usually a combination of firmware and input sensors such as tachometers, or encoders, controlling moving actuators, that are usually motors.

For improved flexibility, some printers are configured to be held by a user to print an image to a substrate. Some examples herein relate to such hand-held or user-propelled printers. Such devices are capable of reliably printing an image to a substrate in a number of print passes of the device across a substrate, such as a garment, for fast transfer of the image to the substrate. If the substrate comprises a garment to be worn by a user, this may enable the fast customization of a wearable garment. Using the hand-held device, the movement of the carriage is replaced by a manual operation, and there is no printing media advance. As the print pass is performed manually, instead of with a controlled speed, print quality may decrease due to the uncertainty of the speed. Therefore, the firmware may be adjusted so that ink drops fire at a speed that is not constant, and which may vary during the printing.

Some techniques may be implemented for speed control in order for a firmware to know where ink drops are to be fired. A firmware of the printer usually fires ink drops according to the speed and in the case that the speed increases or decreases, a firing frequency is adapted accordingly. The higher the speed, the higher firing frequency is implemented, and at low speeds, a lower firing frequency is implemented.

This disclosure describes a system to prevent a user from moving the hand-held printer at inappropriate speeds, e.g., too slow, or too fast to achieve an acceptable print quality.

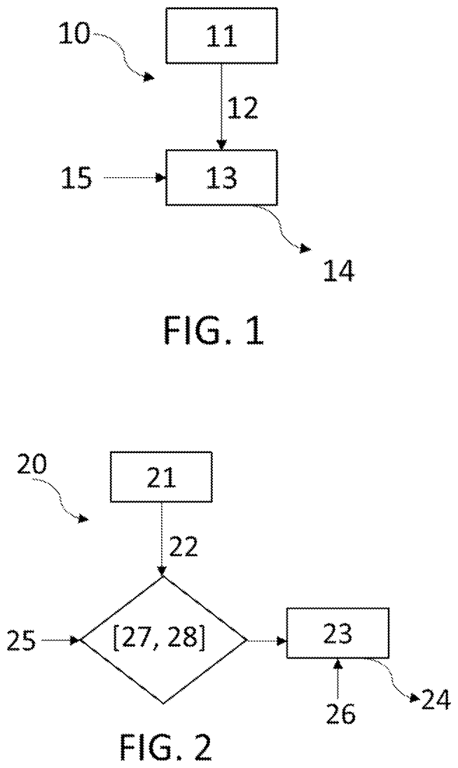

Some examples herein, as shown in FIG. 1, relate to a system 10 for providing feedback to a user of a hand-held inkjet printer, the system comprising
a controller 11 configured to determine an acceptable range of speed 12 of the hand-held printer during printing as a function of a print job; and
a feedback device 13 to provide feedback 14 depending on the acceptable range of speed 12 and a current speed 15 of the hand-held printer during printing.

The system 10 may comprise means or a module for generating an action indicating a user how to use the printer such that a quality of impression is ensured. The action may comprise any change or reaction which gives the user information about the movement the hand-held printer is receiving. For example, a first action may indicate the user that a current movement is appropriate, while a second action may indicate the user about a misuse of the printer while printing.

The system 10 for providing feedback 14 may base such feedback 14 on an acceptable range of speed 12 of the hand-held printer during printing. The acceptable range of speed 12 may be determined based on a print job. The acceptable range of speed 12 may be dynamic and adapt to any changes of the print-job along a printing direction. For example, if a black square is to be printed, a plurality of constant and relatively high speeds may be used, whereas if a colored and detailed image is to be printed, a plurality of relatively slow speeds at certain points along a printing direction may be appropriate, or acceptable. In some examples, power consumption or electrical stress of a printer may vary depending on the content to be printed, and on the number of nozzles activated to fire ink. For example, printing a text or light image may use less ink than a full 100% black image. An image may be analyzed previously to be printed and a maximum speed may be adjusted or controlled. This may allow printing “luminous” content at a higher speed than “darker” content.

The system 10 comprises therefore a controller 11 configured to determine an acceptable range of speed 12 of the hand-held printer during printing as a function of a print job. Determining an acceptable range of speed 12 may comprise acquiring, receiving, estimating, or calculating the acceptable range of speed by the system for providing feedback. The acceptable range of speed 12 may also be read by the system 10 from a memory. The acceptable range of speed 12 may also be read by the controller 11 from an internal memory to the printer or from an external memory to the printer.

A current speed 15 of the hand-held printer during printing may be determined or detected in a plurality of ways. For example, the hand-held printer may comprise an encoder wheel from which a displacement speed may be determined. Optical sensors or accelerometers may also be used for determining the current speed. The current speed 15 may further be derived by an external camera to the hand-held printer by performing image recognition and analysis. Whichever the speed sensor is, the speed sensor may send information to an electronic hardware, and then a firmware may set a speed or may determine an optimal speed for each different print configuration.

In some examples, as shown in FIG. 2, the feedback device 23 is configured to provide feedback 24 if a printing status 26 of the hand-held printer is activated and if the current speed 25 of the hand-held printer is out of the acceptable range of speed 22. A current speed out of an acceptable range of speed may comprise a current speed lower than a low speed limit 27 or a current speed higher than a high speed limit 28. A printing status 26 may be defined as a status of the hand-held printer indicating that a print job is being executed, for example, that the nozzles are activated and firing ink. A printing status 26 may be determined via a flag 26 or signal 26 provided either by the hand-held printer or by any other supervisory device. A printing status may be indicated by the hand-held printer, for example by indicating LEDs, by a sound, or by a buzzer or haptic sensors, by vibrational sensor, and so on.

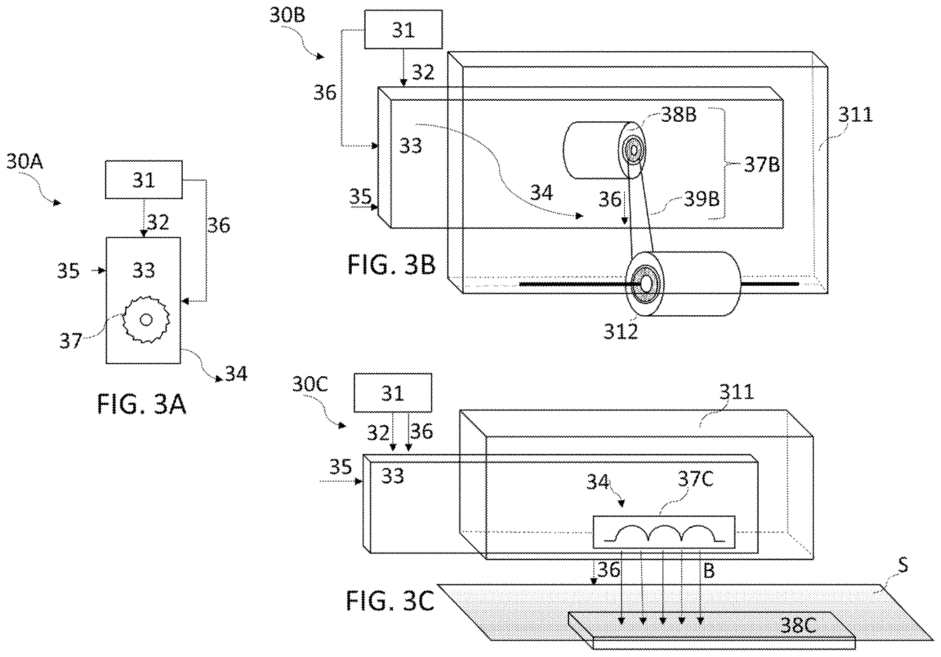

FIGS. 3A, 3B and 3C show systems 30 (30A, 30B and 30C) for providing feedback 34 to a user of a hand-held inkjet printer. The systems 30 comprise a controller 31 configured to determine an acceptable range of speed 32 of the hand-held printer 311 during printing as a function of a print job. The systems 30 further comprise a feedback device 33 to provide feedback 34 depending on the acceptable range of speed 32 and a current speed 35 of the hand-held printer 311 during printing. The controller 31 of the systems 30 is further configured to calculate an acceleration force 36 to be imposed to the hand-held printer 311 and the feedback device 33 comprises a driving unit 37 configured to transmit the feedback 34 to the hand-held printer 311. In such examples, the feedback 34 is the calculated acceleration force 36. The acceleration force 36 is, in such a case, transmitted from the feedback device 33 via the feedback 34. Depending on the current speed 35, a positive acceleration may be appropriate for achieving an acceptable speed falling within an acceptable range of speed 32. A negative acceleration or braking may also be appropriate. On some occasions, the user may try to print or pass the printer too quickly for the nozzles to fire the appropriate amount of ink. In such cases, the systems of this disclosure calculate a negative acceleration or braking force to be imposed onto the hand-held printer. Any movement or displacement may be directly corrected by the system for providing feedback 30. In these examples, the feedback 34 is a corrective action to correct the speed of use of the hand-held printer.

As shown in FIG. 3B, the driving unit 37B may comprise a motor 38B and a drive belt 39B which may transmit an acceleration force 36 to the hand-held printer 311. In the case shown in FIG. 3B, the hand-held printer 311 comprises a displacement wheel 312, such that the feedback 34 comprises transmitting the acceleration force 36 via the drive belt 39 from the motor 38B to the axis of the wheel 312 upon detection of a current speed 35 of the hand-held printer 311 out of the acceptable range of speed 32. The acceleration force may be a braking force.

The driving unit may comprise a DC engine integrated into the displacement wheels and a circuit configured as a dynamic brake system in order to convert the DC engine into an electrical generator, which may produce a counter torque. The more electrical power extracted from the generator, the greater counter torque will be generated on the engine and wheels. By dynamically altering a resistance, for example of a digital variable resistor, the counter torque or brake level applied to the wheels may be controlled. An example of a circuit to regulate an engine torque may comprise a static resistor. The brakes may comprise a variable resistance circuit, etc.

The controller of the system for providing feedback may send a signal to a variable resistance or torque regulator subsystem that may produce appropriate braking. The variable resistance or self-excitation control of the engine may be managed by a firmware and an electronic controller of the hand-held printer, according to the encoder or displacement sensor and on the print job or image content or ink density.

Further or alternative ways to break the hand-held printer may comprise producing a reverse current on the engine in order that the engine rotates on the opposite direction also producing a braking effect. Further or alternative ways to break the hand-held printer may comprise producing an extra load on the engine in order that the engine rotates slower producing a resistance effect.

As seen, the controller 31 may be configured to calculate an acceleration force 36 to be imposed to the hand-held printer and the feedback device 33 may comprise a driving unit 37 configured to transmit the feedback 34 to the hand-held printer 311. In such examples, the feedback 34 is the calculated acceleration force 36. In some examples the feedback device 33 comprises a driving unit 37 which, as shown in FIG. 3C, comprises a magnetic field generator 37C configured to transmit the calculated acceleration force 36 to the hand-held printer 311 via a magnetic field B. The magnetic field generator 37C may be comprised within the hand-held printer 311. In such example, if for example the hand-held printer 311 is used in combination with a support S, the support S may comprise a magnetic material 38C which may be attracted or repelled via the magnetic field B generated at the hand-held printer. The feedback 34 comprises transmitting the acceleration force 36 via the magnetic field B from the magnetic field generator 37C to the magnetic material 38C. If the magnetic field B attracts the magnetic material, for example iron, a braking force is imposed on the hand-held printer and is sensed by the user. In these examples, the feedback provided by the system is corrective. In other examples a hand-held printer may comprise a magnetic material, for example made of iron, and a magnetic field generator may be comprised in a support; the magnetic field may in such case attract or repel the hand-held printer 311, imposing a positive or a negative acceleration thereby.

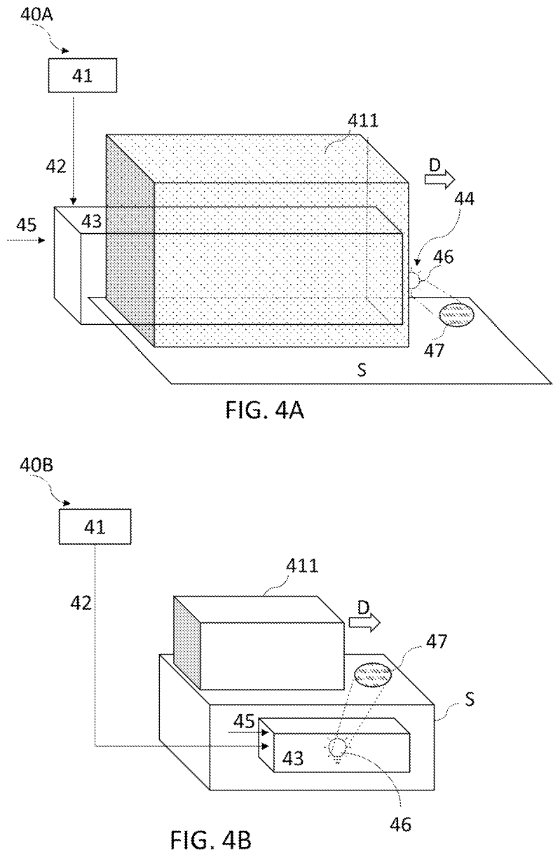

In some examples, alternatively to the examples of FIGS. 3A, 3B and 3C, the controller of the system for providing feedback is further configured to calculate a position relative to the hand-held printer to be signaled and the feedback device comprises a light source configured to light the calculated position. In the case of FIG. 4A the system 40A for providing feedback comprises a controller 41 configured to determine an acceptable range of speed 42 of the hand-held printer 411 during printing as a function of a print job. The system further comprises a feedback device 43 to provide feedback 44 depending on the acceptable range of speed 42 and a current speed 45 of the hand-held printer during printing. The controller 41 is further configured to calculate a position 47 relative to the hand-held printer 411 to be signaled and the feedback device 43 comprises a light source 46 configured to light the calculated position 47. In such example, the feedback 44 is the luminous signal lit by the light source 46. The light source 46 may comprise a LED. The light source 46 may light the calculated position 47 on a support S simulating a movement by turning on and off at a plurality of consecutive calculated positions 47 and at an appropriate speed. The appropriate speed may also be calculated by the system for providing feedback. The light source 46 may light some signals at an appropriate speed in order to indicate the speed that a user has to follow to provide a certain a print quality. The signal may be lit in a cyclic mode by showing multiple times the speed the user has to follow. The light source 46 may comprise a LED strip to light a path to be followed by the hand-held printer at an appropriate speed. The feedback device 43 may be comprised within the hand-held printer 411 or outside the hand-held printer. In the example system 40A of FIG. 4A the feedback device 43 comprising the light source 46 is situated and represented inside the hand-held printer 411. In such example the light source 46 is situated and represented inside the hand-held printer 411. In the example system 40B shown in FIG. 4B the feedback device 43 comprising the light source 46 is situated and represented at least partially outside the hand-held printer 411. In such example the light source 46 is situated and represented outside the hand-held printer 411. The support S is therefore lit from the outside of the hand-held printer.

In FIGS. 4A and 4B the feedback device 43 is represented as a block for simplicity and clarity. It should be understood that the feedback device 43 may comprise a distributed system in which some parts may be external to a hand-held printer 411; for example, the feedback device may comprise a communication module external to the hand-held printer and to the support S and may comprise a light source with a communication interface internal in the hand-held printer or in the support S or in an external structure. In such examples the communication module may indicate the communication interface of the light source at which pace, and at which position 47 the feedback should be provided. FIGS. 4A and 4B show an arrow D indicating a possible printing direction in which the position 47 is positioned.

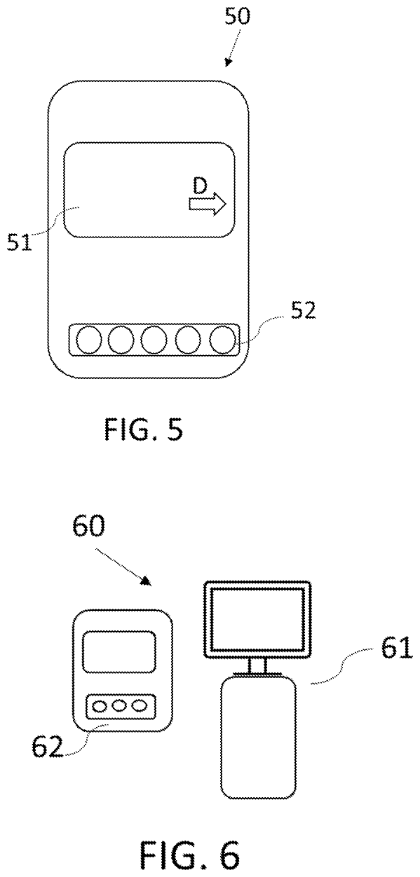

An example system 50 for providing feedback is shown in FIG. 5. The system 50 comprises a heating area 51 delimiting a print zone, a LED strip 52, where the LED strip may be below and parallel to the heating area 51 such that lights may guide a user during printing in a printing direction D parallel to the heating area 51. A user may pass a hand-held printer over the heating area, for example when printing a T-shirt, along the direction D. The LED strip 52 may be in connection or communication to a strip controller. The strip controller may receive a calculated a position relative to the hand-held printer to be signaled and the feedback device comprising the LED strip 52 may be configured to light the calculated position by lighting an appropriate LED in the strip at an appropriate lighting speed. The LED strip may blink a convenient LED to indicate to the user where to place the hand-held device an at which speed. Once the hand-held printer is placed on the heating area 51, the LED strip 52 may execute successive light sequences along the print zone indicating the user how to sweep the hand-held device along the print zone for optimal printing.

As said, the LED strip 52 may be in connection or communication to a strip controller, where the strip controller may comprise a microcontroller STM32 connected to a host controller through a serial bus acting as control link. The system may further comprise a stage of shift registers connected in series to a general-purpose input/output (GPIO) of the microcontroller to control and drive the LED strip. The GPIO may be connected to a 100 KHz clock which may refresh a status of the LED strip at a refresh rate of 390 times per second, providing fluent performance to the LED strip which may be perceived as progressive and accurate, providing a reliable guidance to the printing operation.

In some cases, the system may comprise a matrix of laser diodes placed below the surface of the heating area 51, oriented towards the heating area 51, and lighting the calculated positions, at the appropriate speed, such that the signal to be followed at an appropriate speed by a user is visible on the same heating area, and visible for example on a piece of cloth placed on the heating area.

In some cases, the swapping of the hand-held printer may comprise vertical and horizontal movements and the system may comprise a matrix of laser diodes indicating the appropriate speed in both directions.

The example of FIG. 5 may work as follows: The user may start a printing movement. The LED strip 52 may turn some LEDs ON at the appropriate speed to indicate the speed that the user may follow to maximize a print quality. The LED strip may work in a cyclic mode by showing multiple times the speed the user has to follow, or a cumulative light line.

As seen, the feedback provided by the systems to provide feedback in the present disclosure may provide corrective or active feedback, such as the case of imposing or transmitting an acceleration force to the hand-held printer while printing. The corrective feedback may provide a user with physical feedback while printing in order to learn and correct bad practices or incorrect behavior while moving the hand-held printer along a surface. The feedback provided by the systems to provide feedback in the present disclosure may provide informative feedback, as in the case where the feedback is a luminous signal, and the user is informed of at which speed the hand-held printer is to be passed during printing. Other types of feedback may be provided. For example, in the case of corrective feedback, the acceleration may not only comprise a linear acceleration, but also a directional acceleration; in such a case, the systems to provide feedback would correct the direction and the speed of displacement of the hand-held printer while printing. In the case of informative feedback, the information may not only comprise a luminous signal, but also an auditive signal, or a communication signal such as an alert on a smart watch of a user, or a vibration on a wearable of a user, or any combination of signals or feedbacks, or other type of feedback.

Other types of feedback may be implemented such as the use of LEDs for a standalone hand-held printer. For example, a set of LEDs may be comprised within a hand-held printer. The LEDs may be colored, for example red, yellow, and green. Red may indicate that the user is far from an acceptable speed, for example in a range of 15%-90% above or below an acceptable range of speed, yellow may indicate that a current speed is close to an acceptable range of speed, for example in a range of 1%-14% above or below an acceptable range of speed, and green may indicate that the current speed is within a tolerable or acceptable range of speed.

In the previous examples, if the hand-held printer is used along with a support S, the system for providing feedback may comprise the support S and the support S may comprise or may be part of a printing support or base station comprising a base, heating means and a fan system to cure a print, all embedded in a structure. If the hand-held printer is used to print on a textile, the base may be shaped as a human torso and the impression may be made on a T-shirt or any other piece of cloth. The printing support or base station may further comprise a formatter acting as host of a printing kiosk.

The FIGS. 1, 2, 3A, 3B, 3C, 4A, 4B and 5 show systems to provide feedback which are external to the hand-held printers or at least partially external to the hand-held printer. For example, the controller may be external to the hand-held printer whereas the feedback device may be comprised in the hand-held printer. Other examples comprise the system for providing feedback completely external to the hand-held printer. For example, a system for providing feedback may comprise a printing kiosk. The printing kiosk may comprise the controller, and the feedback device such as LEDs or a speaker or an alarm, so that the kiosk may provide with the acceptable range of speed and a current speed of the hand-held printer during printing and the kiosk may provide with the feedback. The kiosk may comprise a communication module for communicating with the hand-held printer, wherein the communication means may be wired or wireless. FIG. 6 represents a system 60 comprising a kiosk 61 and a base station 62 comprising a system for providing feedback according to some examples of this disclosure. The kiosk 61 may comprise a display and the speed feedback may be shown on the kiosk screen.

A user may interact with a base station to send a print job via a communication module such as a WiFi or a tablet, or mobile phone or any other device to load, edit and send the print job to the host or controller.

The systems to provide feedback of the present disclosure may also be completely comprised in a hand-held printer.

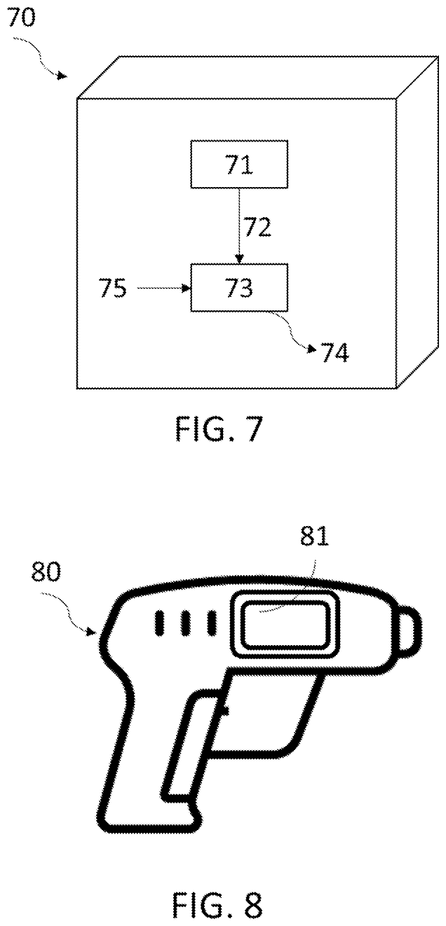

Some examples further relate to a hand-held inkjet printer to be held by a user, as shown in FIG. 7, the hand-held printer 70 comprising:
a controller 71 configured to acquire a printing pace 72 depending on a print job;
means 73 to provide feedback 74 to the user depending on the estimated printing pace 72 and a current pace 75 during printing.

A hand-held printer may be understood as a device comprising a combination of some or all of the following elements: electronic hardware interconnected with sensors, actuators, user interfaces, one or more printheads, and a firmware.

The hand-held printer may comprise an encoder wheel. The encoder wheel may send signals to an electronic control board in order to define a firing speed of nozzles of a print-head.

The hand-held printer may comprise one or more displacement wheels. The displacement wheels may help the printer to move smoothly on a top of a surface when printing and keep a uniform and constant distance between a media and the printer.

The hand-held printer may comprise one or more displacement wheels and means to provide feedback comprising a driving unit and a drive belt, wherein the driving unit is configured to impose a positive or negative acceleration force on the one or more displacement wheels by means of the drive belt.

The hand-held printer may comprise a magnetic displacer configured to receive an acceleration force via a magnetic field. The hand-held printer may comprise a magnetic field generator configured generate a magnetic field to attract or repel a magnetic material to impose an acceleration force via the magnetic field.

The hand-held printer may comprise one or more displacement wheels and a magnetic displacer.

The displacement wheels or the magnetic displacer may be understood as some sliding elements facilitating the movement of the printer, and also as elements keeping the printhead separated a minimum distance from the surface on which the printout is to be made.

In some examples as shown in FIG. 8, the hand-held printer 80 may comprise a display 81 to provide feedback. Such example may be interpreted as a standalone hand-held printer providing feedback. The display 81 may be used for the speed feedback, using colors described with a LEDs system, and the color may be shown somewhere in the display 81.

The display of FIG. 8 may comprise or may be replaced by a LED indicator configured to blink from left to right different indicators: a red LED, a yellow LED, a green LED . . . .

In some examples, a transitory or a non-transitory machine-readable storage medium encoded with instructions executable by a processor, comprises instructions to acknowledge tolerable speed limits or range of speed of the hand-held inkjet printer during impression as a function of a print job and instructions to reckon a current impression speed.

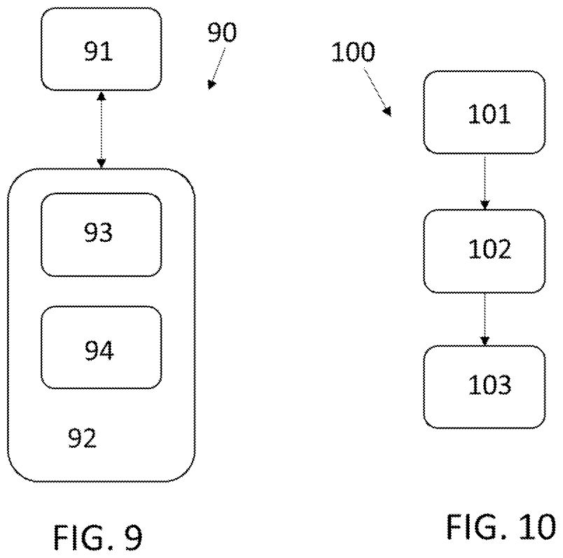

FIG. 9 is a block diagram of an example computer system 90 comprising a processor 91. The processor 91 may fetch, decode, and execute instructions of an instruction set stored on a machine-readable storage medium 92. The medium 92 is encoded with instructions executable by the processor 91, the machine-readable storage medium 92 comprising instructions 93 to acknowledge tolerable speed limits or range of speed of the hand-held inkjet printer during impression as a function of a print job and instructions 94 to reckon a current impression speed. Acknowledge tolerable speed limits of the hand-held inkjet printer during impression as a function of a print job may comprise receive the tolerable speed limits or read the limits from a memory or calculate said tolerable or acceptable speed limits. The tolerable speed limits may be fixed for a whole print job or may be dynamic as a function of changing features of the print job.

In some examples, the processor 91 may control the operation of a system for providing feedback of the present disclosure. In some examples, the processor may be integrated in a hand-held inkjet printer or may be independent from the hand-held inkjet printer.

The medium may further comprise instructions to provide feedback depending on the tolerable speed limits and the current impression speed. The instructions to provide feedback may further comprise providing the feedback to a driving unit.

The computer system 90 or the medium 91 may be comprised in a hand-held printer or may be comprised in a system for providing feedback according to the present disclosure.

The machine-readable storage medium or data storage may be any electronic, magnetic, optical, or other physical storage device that contains or stores executable instructions. Thus, the machine-readable storage medium may be, for example, Random Access Memory (RAM), an Electrically Erasable Programmable Read-Only Memory (EEPROM), a storage device, an optical disc, and the like. In some implementations, the machine-readable storage medium may be a non-transitory machine-readable storage medium, where the term “non-transitory” does not encompass transitory propagating signals. Machine-readable storage medium may be encoded with a series of instructions executable by a processor. The instructions may cause a processor to carry out any of the methods described herein below.

The present disclosure describes a method for reacting to a usage of a hand-held inkjet printer. The reaction provides feedback to a user of the hand-held inkjet printer. The reaction may comprise haptic reaction or a visual reaction or a sound reaction. FIG. 10 shows an example method 100, wherein the method 100 comprises, in block 101, providing tolerable speed limits of the hand-held inkjet printer for printing a print job, wherein providing may comprise acquiring, reading from a memory, calculating, estimating, dynamically adapting, etc. Block 102 represents detecting a printing status and a current speed of the hand-held printer out of the tolerable speed limits. Block 103 represents providing a rection based on a comparison between the tolerable speed limits and the current speed of the hand-held printer.

The method 100 may further comprise calculating an acceleration force to be imposed to the hand-held printer based on a comparison between the tolerable speed limits and the current speed of the hand-held printer and transmitting the calculated acceleration force to the hand-held printer.

The method 100 may further comprise calculating a position relative to the hand-held printer to be signaled based on a comparison between the tolerable speed limits and the current speed of the hand-held printer and lighting the calculated position. The lighted position is comprised in an area external to the area covered by the hand-held printer during printing so that it can be seen by a user.

Some of the advantages provided by the systems, hand-held printers, mediums, and methods of the present disclosure may comprise qualitative advantages: the print quality of a hand-held inkjet printer is improved in the cases where the hand-held printer user may not be trained or may not have enough experience, as the feedback makes easier the management of the printer. While using the systems of this disclosure, a user is guided by not allowing certain sudden speed change behaviors, for example. The user may learn how to best use a hand-held printer since the feedback may not allow the user to effectuate sudden changes thereby producing a good output print quality. In other cases, the user is informed of how not to use the hand-held printer for the user to correct the current use of the printer.

By implementing the systems and methods of the present description power consumption may be minimized: the worst case while printing, related to power consumption, occurs when printing a 100% opaque surface. In this case all the nozzles are fired almost at the same time in order to fill the surface entirely in one pass. A high speed displacement of the printhead or the hand-held printer while printing may require a high amount of electrical power to trigger all the nozzles firing at the high speed and a peak may be generated that may affect the electronics, an overheat of the device or the printhead, or require a different and more powerful power supply. By controlling the speed, the power spent may be controlled.

The preceding description has been presented to illustrate and describe certain examples. Different sets of examples have been described; these may be applied individually or in combination, sometimes with a synergetic effect. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

1. A system for providing feedback to a user of a hand-held inkjet printer, the system comprising
a controller configured to determine an acceptable range of speed of the hand-held printer during printing as a function of a print job;
a feedback device to provide feedback depending on the acceptable range of speed and a current speed of the hand-held printer during printing.

2. The system of claim 1 wherein the feedback device is configured to transmit feedback:
if a printing status of the hand-held printer is activated and
if the current speed of the hand-held printer is out of the acceptable range of speed.

3. The system of claim 1, wherein
the controller is further configured to calculate an acceleration force to be imposed to the hand-held printer;
the feedback device comprises a driving unit configured to transmit the calculated acceleration force to the hand-held printer.

4. The system of claim 1, wherein
the controller is further configured to calculate a position relative to the hand-held printer to be signaled;
the feedback device comprises a light source configured to light the calculated position.

5. The system of claim 4 wherein the light source comprises a LED.

6. The system of claim 1, to wherein the feedback device comprises magnetic field generator configured to transmit the calculated acceleration force to the hand-held printer via a magnetic field.

7. The system of claim 1, further comprising a hand-held printer.

8. The system of claim 1, to further comprising a printing support or base station or a printing kiosk.

9. The system of claim 1, wherein the feedback device comprises one or more of a LED strip, an alarm generator, a communication module.

10. A hand-held inkjet printer to be held by a user, the printer comprising
a controller configured to acquire a printing pace depending on a print job;
means to provide feedback to the user depending on the estimated printing pace and a current pace during printing.

11. The hand-held printer of claim 10 further comprising one or more displacement wheels.

12. The hand-held printer of claim 11 wherein the means to provide feedback comprise a driving unit and a drive belt, wherein the driving unit is configured to impose a positive or negative acceleration force on the one or more displacement wheels by means of the drive belt.

13. The hand-held printer of claim 10, further comprising a magnetic displacer configured to receive an acceleration force via a magnetic field.

14. (canceled)

15. A non-transitory machine-readable storage medium encoded with instructions executable by a processor, the machine-readable storage medium comprising:
instructions to acknowledge tolerable speed limits of the hand-held inkjet printer during impression as a function of a print job;
instructions to reckon a current impression speed.

16. The medium of claim 15 further comprising instructions to provide feedback depending on the tolerable speed limits and the current impression speed.

17. A method for reacting to a usage of a hand-held inkjet printer, the method comprising:
providing tolerable speed limits of the hand-held inkjet printer for printing a print job;
upon detection of a printing status and of a current speed of the hand-held printer out of the tolerable speed limits, providing a rection based on a comparison between the tolerable speed limits and the current speed of the hand-held printer.

18. The method of claim 17 further comprising
calculating an acceleration force to be imposed to the hand-held printer;
transmitting the calculated acceleration force to the hand-held printer.

19. The method of claim 17, or further comprising
calculating a position relative to the hand-held printer to be signaled;
lighting the calculated position.

20. The method of claim 19 wherein calculating the position comprises calculating said position in an area external to the area covered by the hand-held printer during printing.
